(19) United States
(12) Patent Application Publication
(10) Pub. No.: US 2024/0386254 A1
(43) Pub. Date: Nov. 21, 2024

(54) SIGNAL ENCODING AND RECONSTRUCTION VIA SPIKING NEURON MODELING

(71) Applicant: University of Florida Research Foundation, Incorporated, Gainesville, FL (US)

(72) Inventors: Arunava Banerjee, Gainesville, FL (US); Anik Chattopadhyay, Gainesville, FL (US)

(21) Appl. No.: 18/659,107

(22) Filed: May 9, 2024

Related U.S. Application Data
(60) Provisional application No. 63/502,735, filed on May 17, 2023.

(51) Int. Cl. G06N 3/049; G06N 3/042

(52) U.S. Cl. CPC G06N 3/049; G06N 3/042

(57) ABSTRACT

A method and system are directed to signal coding and reconstruction. The method comprises receiving an input signal, generating a spike train representation based on the input signal, determining a plurality of reconstruction coefficients based on the spike train representation, and generating a reconstructed signal based on the plurality of reconstruction coefficients.

### CROSS REFERENCE TO RELATED APPLICATION

This application claims the priority of U.S. Provisional Application No. 63/502,735,entitled “SIGNAL ENCODING AND RECONSTRUCTION VIA SPIKING NEURON MODELING,” filed on May 17, 2023, the disclosure of which is hereby incorporated by reference in its entirety.

### TECHNICAL FIELD

Various embodiments of the present disclosure relate to artificial neurons, and more particularly to encoding and decoding continuous time signals based on a spiking neuron model.

### BACKGROUND

In most animals, sensory stimuli are communicated to the brain via ensembles of discrete spatio-temporally compact electrical events that are generated by neurons, known as action potentials or spikes. Existing techniques for generating a sensory stimuli representation of a continuous time signal using spike trains may be achieved via a rate code, which may be analyzed via pulse density coding and Sigma-Delta modulators. However, the use of spike codes may achieve high reconstruction accuracy while being much sparser/leaner than would be warranted by a rate code. Sparse/lean spike trains may be intrinsically more energy efficient and may also facilitate downstream computation. There is thus a need for an effective end-to-end signal processing framework for deterministically representing signals via lean spike train ensembles.

BRIEF SUMMARY

Various embodiments described herein relate to methods, apparatuses, and systems for signal coding and reconstruction based on spiking neuron modeling.

According to one embodiment, a method comprises receiving, by one or more processors, an input signal; generating, by the one or more processors, a spike train representation based on the input signal; determining, by the one or more processors, a plurality of reconstruction coefficients based on the spike train representation; and generating, by the one or more processors, a reconstructed signal based on the plurality of reconstruction coefficients.

In some embodiments, the input signal comprises a continuous time signal. In some embodiments, the input signal comprises at least one of: an audio signal, a video signal, or a combination thereof. In some embodiments, the spike train representation comprises a sequence of one or more spikes that are representative of one or more neuron spikes generated by one or more neurons in response to the input signal. In some embodiments, generating the spike train representation further comprises encoding the input signal based on one or more convolution kernels. In some embodiments, the one or more convolution kernels comprises respective one or more kernel functions. In some embodiments, the one or more kernel functions are associated with respective one or more time-varying thresholds.

According to one embodiment, a system comprises an encoding module configured to: receive an input signal, generate a spike train representation based on the input signal; and a decoding module configured to: determine a plurality of reconstruction coefficients based on the spike train representation, and generate a reconstructed signal based on the plurality of reconstruction coefficients.

In some embodiments, the input signal comprises a continuous time signal. In some embodiments, the input signal comprises at least one of: an audio signal, a video signal, or a combination thereof. In some embodiments, the spike train representation comprises a sequence of one or more spikes that are representative of one or more neuron spikes generated by one or more neurons in response to the input signal. In some embodiments, the encoding module is further configured to encode the input signal based on one or more convolution kernels. In some embodiments, the one or more convolution kernels comprises respective one or more kernel functions. In some embodiments, the one or more kernel functions are associated with respective one or more time-varying thresholds.

According to one embodiment, one or more non-transitory computer-readable storage media including instructions that, when executed by one or more processors, cause the one or more processors to: receive an input signal; generate a spike train representation based on the input signal; determine a plurality of reconstruction coefficients based on the spike train representation; and generate a reconstructed signal based on the plurality of reconstruction coefficients.

In some embodiments, the input signal comprises at least one of: an audio signal, a video signal, or a combination thereof. In some embodiments, the spike train representation comprises a sequence of one or more spikes that are representative of one or more neuron spikes generated by one or more neurons in response to the input signal. In some embodiments, the one or more processors are further caused to encode the input signal based on one or more convolution kernels. In some embodiments, the one or more convolution kernels comprises respective one or more kernel functions. In some embodiments, the one or more kernel functions are associated with respective one or more time-varying thresholds.

### BRIEF DESCRIPTION OF THE DRAWINGS

Embodiments incorporating teachings of the present disclosure are shown and described with respect to the figures presented herein.

FIG. 1 provides an exemplary overview of an architecture that may be used to practice embodiments of the present disclosure.

FIG. 2 provides an example neuron computing entity in accordance with some embodiments discussed herein.

FIG. 3 provides an example client computing entity in accordance with some embodiments discussed herein.

FIG. 4 is an operational example of encoding performed for a single kernel by an encoding module in accordance with some embodiments discussed herein.

FIG. 5 is a schematic diagram of an example spike coding framework in accordance with some embodiments discussed herein.

FIG. 6 is a flowchart of an example process for signal coding and reconstruction by modeling neuron spikes in accordance with some embodiments discussed herein.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Exemplary Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically crasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (c.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

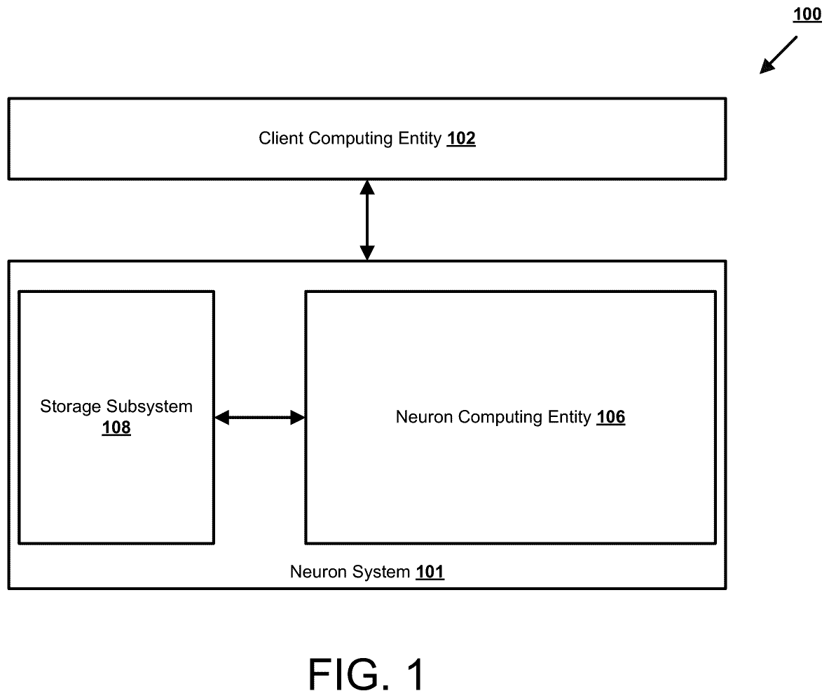

FIG. 1 is a schematic diagram of an example architecture 100 for signal coding and reconstruction by spiking neuron modeling. The architecture 100 includes a neuron system 101 that is configured to receive signals from client computing entity 102, process the signals to generate outputs, and provide the generated outputs to the client computing entity 102.

In some embodiments, neuron system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The neuron system 101 may include a neuron computing entity 106 and a storage subsystem 108. The neuron computing entity 106 may be configured to receive signals from one or more of client computing entity 102, process the signals to generate outputs corresponding to the signals, and provide the generated outputs to the one or more client computing entity 102.

The storage subsystem 108 may be configured to store input data used by the neuron computing entity 106 to perform signal encoding and decoding. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FcRAM, NVRAM, MRAM, RRAM, SONOS, FJG RAM, Millipede memory, racetrack memory, and/or the like.

### Example Neuron Computing Entity

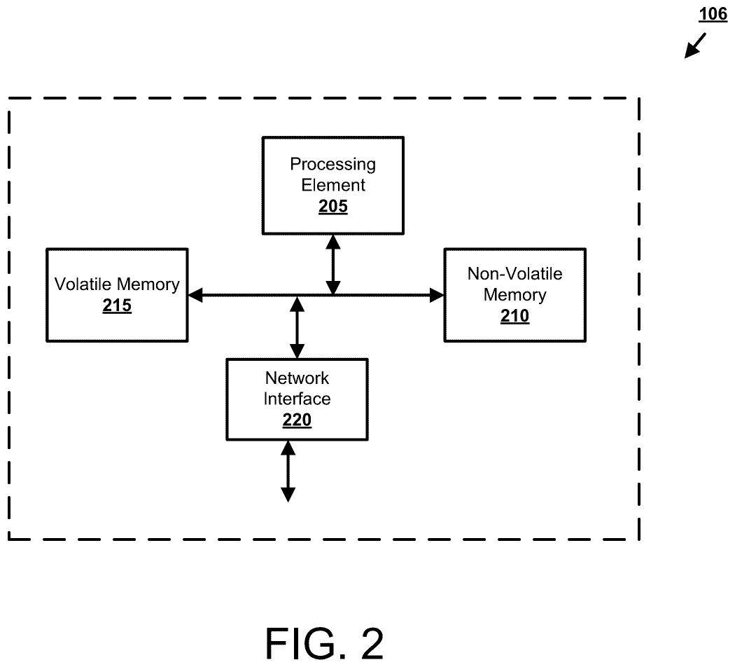

FIG. 2 provides a schematic of a neuron computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the neuron computing entity 106 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the neuron computing entity 106 may include, or be in communication with, a processing element 205 (also referred to as processors, processing circuitry, and/or similar terms used herein interchangeably) that communicate with other elements within the neuron computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the neuron computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the neuron computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the neuron computing entity 106 with the assistance of the processing element 205 and operating system.

As indicated, in one embodiment, the neuron computing entity 106 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the neuron computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the neuron computing entity 106 may include, or be in communication with, one or more input elements, such as a keyboard input, a mouse input, a touch screen/display input, motion input, movement input, audio input, pointing device input, joystick input, keypad input, and/or the like. The neuron computing entity 106 may also include, or be in communication with, one or more output elements (not shown), such as audio output, video output, screen/display output, motion output, movement output, and/or the like.

### Exemplary Client Computing Entity

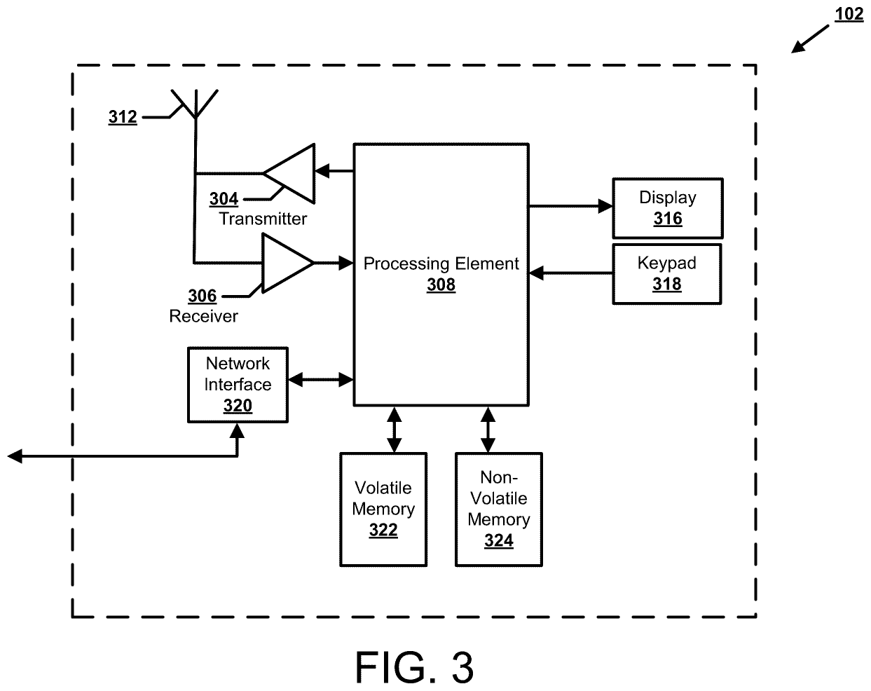

FIG. 3 provides an illustrative schematic representative of a client computing entity 102 that may be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing clement 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the neuron computing entity 106. In a particular embodiment, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the neuron computing entity 106 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (c.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stercographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the neuron computing entity 106, as described herein. The user input interface may comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the neuron computing entity 106 and/or various other computing entities.

In another embodiment, the client computing entity 102 may include one or more components or functionality that are the same or similar to those of the neuron computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity. Accordingly, the client computing entity 102 may be configured to provide and/or receive information/data from a user via an input/output mechanism, such as a display, a camera, a speaker, a voice-activated input, and/or the like. In certain embodiments, an Al computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary System Operations

Various embodiments of the present disclosure describe steps, operations, processes, methods, functions, and/or the like for generating spike-based representations of continuous time signals. In some embodiments, a spike coding framework is provided for coding and reconstructing continuous time signals via a coding mechanism that is biologically plausible. The disclosed spike coding framework may comprise encoding a signal through spike trains generated by an ensemble of artificial neurons via a convolve-then-threshold mechanism with a variety of convolution kernels. Reconstruction of the signal may comprise a convex optimization minimizing energy. In some embodiments, a spike may be representative of an occurrence of an event or an action potential, analogous to signals generated by biological neurons to communicate with one another. Accordingly, a spike train may comprise a combinational sequence of spikes comprising a digital sequence of information.

According to various embodiments of the present disclosure, the disclosed spike coding framework comprises an encoding module and a decoding module. The encoding module may comprise one or more encoding neurons configured to convert a continuous time signal into a spike-based representation. The decoding module may comprise reconstruction coefficients, associated with the spike-based representation, configured to reconstruct the continuous time signal.

Encoding Module

According to various embodiments of the present disclosure, an encoding module may receive a set of input signals ( [symbol] ) comprising a class of finite support bounded square integrable function F [symbol] ={X(t)|X(t)∈L²[0,T]}, for some upper bound time T∈ [symbol] ⁺, where T may be chosen without loss of generality. The encoding module may comprise an ensemble of convolution kernels K={K^{j}|j∈Z⁺, j≤n}, representative of spiking neurons and each characterized by a kernel function K^{j}(t), j=1, . . . , n, where ∀j∈{1, . . . , n}, K^{j}(t)∈C[0,T], T∈ [symbol] ⁺. K^{j} may have a time-varying threshold denoted by T^{j}(t).

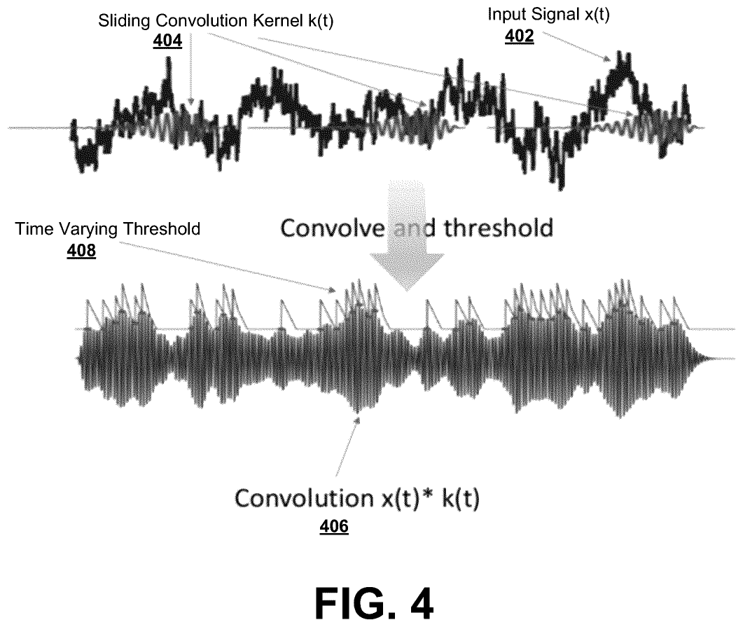

The ensemble of convolution kernels K may be applied to a given input signal X(t) to encode the input signal X(t) into a sequence of one or more spikes (e.g., a spike train) {(tᵢ, K^{ji})}, where the i^{th} spike may be produced by the jᵢ^{th} kernel K^{ji} at time tᵢ, for example, if and only if: f X(τ) K^{j} (tᵢ−τ)dτ=T^{ji}(tᵢ), where t may represent a variable of integration. A simplified threshold function may be used in which the time-varying threshold T^{ji}(t) of the jth kernel remains constant at C^{j}until the jth kernel produces a spike, at which time an after-hyperpolarization potential (ahp) increments the threshold by a value M^{j}. The increment may decline to zero linearly within a refractory period &j. In some embodiments, the varying threshold T^{j}(t) may be calculated by the following equation:

$${T}^{j} ( t ) = {C}^{j} + {\sum }_{{t}_{p}^{j} ∈ [ t , t - {δ}_{j} ]} {M}^{j} - \frac{{M}^{j} ( t - {t}_{p}^{j} )}{{δ}_{j}} \qquad Equation 1$$

where the sum may be taken over spike times tₚ^{j} in the interval t to t−δⱼ at which kernel K^{j} generates a spike. Such a threshold may model a neuron that stays quiescent as long as the signal is uncorrelated with its kernel K^{j} and starts firing when the correlation reaches a certain threshold and continues to fire at higher threshold levels communicating increasing correlation levels, which may be inhibited by previous spikes. Probing signals via a lockstep series of spikes is depicted in FIG. 4.

FIG. 4 depicts an operational example of encoding performed for a single kernel by an encoding module. An input signal x(t) 402 is depicted overlayed with a sliding convolution kernel k(t) 404. The sliding convolution kernel k(t) 404 may be applied to the input signal x(t) 402 with a time-varying threshold function 408 to generate convolution x(t)*k (t) 406. Spikes times are depicted in FIG. 4 at crossings over the threshold levels of the time-varying threshold 408 by the convolution x(t)*k(t) 406.

### Decoding Module

According to various embodiments of the present disclosure, a decoding module may be configured to reconstruct an input signal based on the encoding of the input signal as a sequence of one or more spikes. The reconstructed signal may satisfy a same set of constraints as the input signal as encoded by, e.g., via an ensemble of convolution kernels K. The reconstructed signal, denoted by X*(t) of the input signal X (t), may comprise the solution to the following optimization problem:

$$\begin{matrix}X * ( t ) = \begin{matrix}arg min {‖ \tilde{X} ( t ) ‖}_{2}^{2} \\ \tilde{X}\end{matrix} \\ s . t . \int \tilde{X} ( τ ) {K}^{{j}_{i}} ( {t}_{i} - τ ) d τ = {T}^{{j}_{i}} ( {t}_{i} ) ; 1 \leq i \leq N\end{matrix} \qquad Equation ( s ) 2$$

where {(tᵢ, K^{ji})|i∈{1, . . . , N}} may represent the set of all spikes generated by convolution kernels K associated with encoding neurons of the encoder module. A reconstructed signal may comprise minimum L2-norm. The choice of L2 minimization may be in congruence with a dictum of energy efficiency in biological systems. That is, of all signals, the one with minimum energy that is consistent with the spike trains is desirable. Also, a L2 minimization of Equation 2 may reduce the convex optimization problem to a solvable linear system of equations.

A solution to Equation(s) 2, may comprise a linear combination of shifted kernel functions, K^{ji}(t₁−t) so that the reconstructed signal X*(t) may be expressed as:

$$X * ( t ) = {\sum }_{i = 1}^{N} {α}_{i} {K}^{ji} ( {t}_{i} - t ) , \qquad Equation 3$$

where αᵢ may represent reconstruction coefficients. The reconstruction coefficients αᵢ∈ [symbol] may be solved from a system of linear equations Pα=T. P may comprise a Gram matrix of dimension N×N where each entry of P-matrix may be given by:

$${P}_{ik} = \int {K}^{jk} ( {t}_{k} - τ ) {K}^{ji} ( {t}_{i} - τ ) d τ \qquad Equation 4$$

and T=[T₁, . . . , T_{N}]^{T} may represent threshold values at which the spikes were produced. For efficient computation and to obtain a stable solution, instead of solving a Pα=T in its entirety, e.g., inverting a big N×N matrix, the solution may be computed iteratively for each spike using a restricted window size w.

Table 1 provides example parameters and associated descriptions that may be used for the disclosed spike coding framework.

TABLE 1

| | |
|---|---|
| number of kernels | Number of kernels used to encode the signal. |
| | For audio snippet experiments, gammatone |
| | kernels, uniformly spaced in ERB scale, may |
| | be used. Number of kernels vary up to 200. |
| sample length | Length of the signal considered for |
| | reconstruction. |
| Up-sample factor | Signals may be upsampled for better |
| | reconstruction and accurate calculation of |
| | convolution, thresholds etc. Up-sample factor |
| | may indicate the factor by which an input |
| | signal, the kernels, and the corresponding |
| | convolution values are up-sampled. |
| window size | In iterative reconstruction, every incoming |
| | spike reconstruction may be updated. In this |
| | scheme, finite window-sized set of spikes may |
| | be considered for a reconstruction update |
| | instead of considering all the previous spikes. |
| | This window size in turn may depend on the |
| | density of spikes, which on the other hand may |
| | be governed by the ahp period of each kernel. |
| baseline spiking | This may represent the baseline threshold for |
| threshold | each kernel to produce a spike as indicated in |
| | Equation 1. |
| ahp high | This may represent the increment in threshold |
| | value every time a spike occurs as given in |
| | Equation 1. |
| ahp period | This may comprise a refractory period as |
| | indicated in Equation 1. |

The following example algorithms for performing signal encoding (Algorithm 1) and decoding (Algorithm 2) using the disclosed spike coding framework are disclosed:

```
Algorithm 1 Pseudo code for the encoding algorithm.
Input: A continuous time signal X where X ∈ R^{N} for audio signal (X ∈ R^{L} × R^{M} × R^{N} for a video
signal) where L, M, N ∈ [symbol]  ⁺.
A bag of kernels
        K = {K^{j}|j ∈ Z⁺, j ≤ n, ∥k^{j}∥ = 1}
  where k^{j} ∈ R^{Nj}, Nⱼ ∈ [symbol]  ⁺ are kernel functions for audio signals (for video signals K^{j} ∈ ∈ R^{Lj} ×
  R^{Mj} × R^{Nj}, R^{Nj} ∈ [symbol]  ⁺).
Set of parameter values as indicated in table 1.
Coding:
  S ← Φ [symbol]   Initialize the set of spikes as empty set.
  C[1, . . . , M] ← 0 [symbol]   Initialize the convolution values to 0.
  T[1, . . . , M] ← 0 [symbol]   Initialize the threshold values of each kernel.
for i ∈ [1, . . . , M] do
  C[i] ← X [symbol]   Kⁱ [symbol]   set the signal kernel convolution values.
  T[i] ← baseline [symbol]   Set the baseline threshold for each kernel.
end for
    while t ∈ [0, N] do [symbol]   Loop through the entire duration of the signal.
      for i ∈ [1, . . . , M] do
        Ti = T[t] [symbol]   baseline threshold.
        for (tₗ, K^{jl}, Tₗ) ∈ S do [symbol]   for each previous spike.
          if t < tₗ + δⁱ and jₗ == i then [symbol]   If the previous spike was due to the same kernel
    and within its refractory period, add its inhibitory effect as shown in Equation 1.
            ${T}_{i} = {T}_{i} + ( {M}_{i} - \frac{{M}_{i} * ( t - {t}_{l} )}{{δ}_{j}}$
        end if
      end for
        if C[i][t] ≥ Tᵢ then append (t, Kⁱ, C[i][t]) to S [symbol]   Produce a new spike if threshold is
        crossed.
      end if
    end for
  end while
Output: Sequence of spikes S.
```

Algorithm 2 Pseudo code for the decoding algorithm.

Input: Set of spikes S generated by the encoder in Algorithm 1.
Decoding:

| | |
|---|---|
| X* = 0 | [symbol] Initialize the reconstruction values to 0. |
| P = [ ] | [symbol] Initialize empty P matrix. |
| α = [ ] | [symbol] Initialize empty coefficient vector. |
| N = 0 | [symbol] Initialize the size of P matrix to 0. |
| For (tᵢ, K^{ji}, Tᵢ) ∈ S do | [symbol] loop through each spike. |

```
    N = N + 1
    newRow = [1, ..., 1]_{1×N}
    for k ∈ [1, ..., N − 1] do
      (tₖ, K^{jk}, Tₖ)
      newRow[k] = [symbol]   (K^{ji} (tᵢ − t), K^{jk} (tₖ − t) [symbol]
    end for
    newRow[N] = 1
    append row newRow[: N − 1] to P
    append column newRow^{T} to P
```

| | |
|---|---|
| P_{w}in = P[N − w :, N − w :] | [symbol] Consider windowed P matrix instead of the full P matrix. |

```
    T = [0, ..., 0]_{w×1}
    T[1] = Tᵢ − α[N − w : N − 1] ·newRow[N − w : N −1] [symbol]   Calculate the inner product
  between new spike and residual error signal.
    α[N − w : N] = α[N − w : N] + T· P_{win}⁻¹ [symbol]   Update the reconstruction based on the ith
  spike.
  End for
  X* = Σᵢα[i] * K^{ji}(tᵢ − t)
Output: X*
```

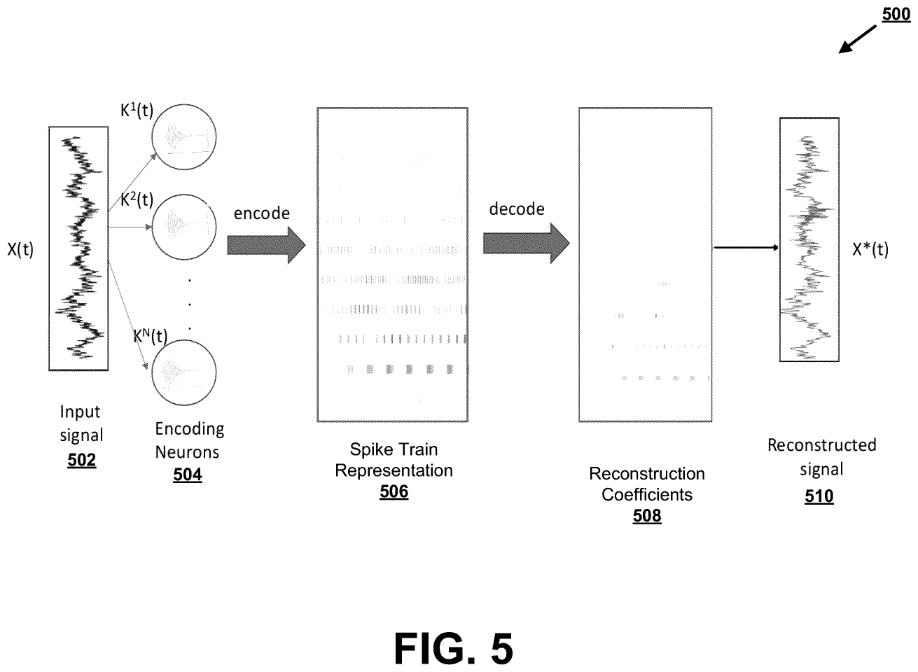

FIG. 5 depicts a schematic diagram of an example spike coding framework for coding and decoding continuous time signals. Spike coding framework 500 comprises a plurality of encoding neurons 504 (e.g., of an encoding module). The plurality of encoding neurons 504 may (i) comprise one or more convolution kernels, (ii) be configured to receive an input signal 502, and (iii) generate a spike train representation 506 based on the input signal 502 by encoding the input signal 502 based on one or more convolution kernels. In some embodiments, the input signal 502 comprises a continuous time signal. In some embodiments, the input signal 502 comprises at least one of an audio signal, a video signal, or a combination thereof.

A convolution kernel may comprise a kernel function that models a spiking neuron. In some embodiments, spike train representation 506 may comprise a sequence of one or more spikes generated by transforming the input signal 502 via the encoding neurons 504. In some embodiments, the spike train representation 506 comprises a sequence of one or more spikes that are representative of one or more neuron spikes generated by the encoding neurons 504 in response to the input signal 502. In some embodiments, a convolution kernel comprises one or more kernel functions. In some embodiments, the one or more kernel functions are associated with one or more time-varying thresholds.

The input signal 502 may be decoded from its spike train representation 506 (c.g., by a decoding module) as a reconstructed signal 510 by determining and using a plurality of reconstruction coefficients 508 that are associated with respective spikes in the spike train representation 506. As such, reconstructed signal 510 may be generated based on the plurality of reconstruction coefficients.

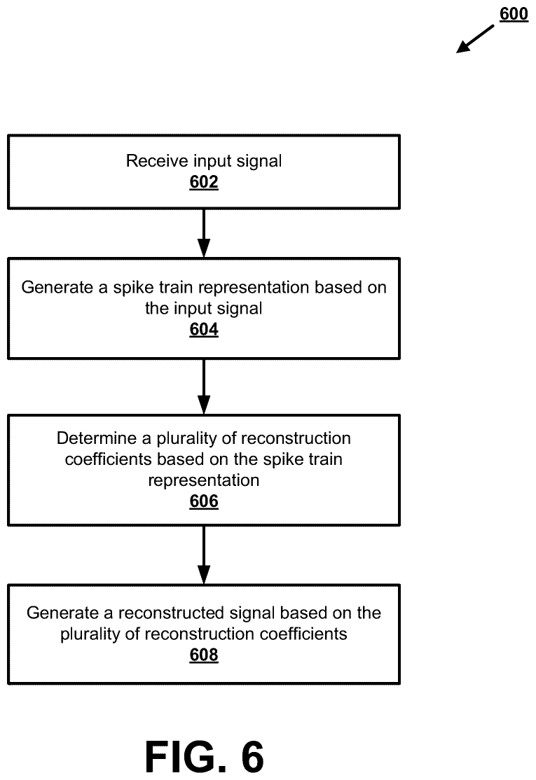

FIG. 6 presents a flowchart of an example process for signal coding and reconstruction by modeling neuron spikes according to some embodiments of the present disclosure. The process 600 includes example operations that may be performed by one or more instances of the neuron computing entity 106, for example, one or more first neuron computing entity may comprise an encoding module and perform steps associated with signal encoding and one or more second neuron computing entity may comprise a decoding module and perform steps associated with signal reconstruction. A neuron computing entity 106 comprises means, such as processing element 205, memories 210 and 215, network interface 220, and/or the like, for performing the example operations.

In some embodiments, at step 602, one or more neuron computing entities (c.g., associated with an encoding module) receive an input signal. The input signal may comprise a continuous time signal. For example, the input signal may comprise an audio signal, a video signal, or a combination thereof.

In some embodiments, subsequent to step 602, at step 604, the one or more neuron computing entities (e.g., associated with an encoding module) generate a spike train representation based on the input signal. A spike train representation may comprise a sequence of one or more spikes that are representative of one or more neuron spikes generated by a neuron in response to the input signal. Generating the spike train representation may comprise encoding the input signal by, for example, one or more encoding neurons associated with respective one or more convolution kernels. In some embodiments, an ensemble of convolution kernels may be applied to the input signal to encode the input signal into a sequence of one or more spikes comprising a spike train representation. A convolution kernel may comprise a representative function associated with a spiking neuron. In some embodiments, a convolution kernel may comprise a mathematical operation (e.g., a kernel function) associated with a data object, such as a matrix, used to perform a convolution with the input signal to encode features (e.g., a neuron spike) from the input signal to a spike train representation. In some embodiments, a convolution kernel comprises one or more kernel functions that are associated with one or more time-varying thresholds.

In some embodiments, subsequent to step 604, at step 606, the one or more neuron computing entities (e.g., associated with a decoding module) determine a plurality of reconstruction coefficients based on the spike train representation. That is, the plurality of reconstruction coefficients may be determined from spikes in the spike train representation generated based on the convolution kernels of the one or more encoding neurons. According to various embodiments of the present disclosure, the plurality of reconstruction coefficients may be determined by using, for example, Equations 2 through 4.

In some embodiments, subsequent to step 606, at step 608, the one or more neuron computing entities (e.g., associated with a decoding module) generate a reconstructed signal based on the plurality of reconstruction coefficients. The input signal may be decoded from the spike train representation as a reconstructed signal by using reconstruction coefficients associated with respective spikes in the spike train representation.

Accordingly, the present disclosure provides a spike coding framework for representing continuous time signals with an ensemble of spike trains, from which the continuous time signals may be recovered. The disclosed spike coding framework may be used in the field of signal processing for capturing information from a continuous-time signal and may provide an improvement over Nyquist-Shannon theory. In particular, instead of sampling the value of a function at uniform or nonuniform prespecified sample points, the disclosed spike coding framework comprises a coding scheme that samples points (non-uniform) of a function at specific convolved values.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method for signal coding and reconstruction, the method comprising:
receiving, by one or more processors, an input signal;
generating, by the one or more processors, a spike train representation based on the input signal;
determining, by the one or more processors, a plurality of reconstruction coefficients based on the spike train representation; and
generating, by the one or more processors, a reconstructed signal based on the plurality of reconstruction coefficients.

2. The computer-implemented method of claim 1, wherein the input signal comprises a continuous time signal.

3. The computer-implemented method of claim 1, wherein the input signal comprises at least one of: an audio signal, a video signal, or a combination thereof.

4. The computer-implemented method of claim 1, wherein the spike train representation comprises a sequence of one or more spikes that are representative of one or more neuron spikes generated by one or more neurons in response to the input signal.

5. The computer-implemented method of claim 1, wherein generating the spike train representation further comprises encoding the input signal based on one or more convolution kernels.

6. The computer-implemented method of claim 5, wherein the one or more convolution kernels comprises respective one or more kernel functions.

7. The computer-implemented method of claim 6, wherein the one or more kernel functions are associated with respective one or more time-varying thresholds.

8. A system comprising:
an encoding module configured to:
receive an input signal,
generate a spike train representation based on the input signal; and
a decoding module configured to:
determine a plurality of reconstruction coefficients based on the spike train representation, and
generate a reconstructed signal based on the plurality of reconstruction coefficients.

9. The system of claim 8, wherein the input signal comprises a continuous time signal.

10. The system of claim 8, wherein the input signal comprises at least one of: an audio signal, a video signal, or a combination thereof.

11. The system of claim 8, wherein the spike train representation comprises a sequence of one or more spikes that are representative of one or more neuron spikes generated by one or more neurons in response to the input signal.

12. The system of claim 8, wherein the encoding module is further configured to encode the input signal based on one or more convolution kernels.

13. The system of claim 12, wherein the one or more convolution kernels comprises respective one or more kernel functions.

14. The system of claim 13, wherein the one or more kernel functions are associated with respective one or more time-varying thresholds.

15. One or more non-transitory computer-readable storage media including instructions that, when executed by one or more processors, cause the one or more processors to:
receive an input signal;
generate a spike train representation based on the input signal;
determine a plurality of reconstruction coefficients based on the spike train representation; and
generate a reconstructed signal based on the plurality of reconstruction coefficients.

16. The one or more non-transitory computer-readable storage media of claim 15, wherein the input signal comprises at least one of: an audio signal, a video signal, or a combination thereof.

17. The one or more non-transitory computer-readable storage media of claim 15, wherein the spike train representation comprises a sequence of one or more spikes that are representative of one or more neuron spikes generated by one or more neurons in response to the input signal.

18. The one or more non-transitory computer-readable storage media of claim 15, wherein the one or more processors are further caused to encode the input signal based on one or more convolution kernels.

19. The one or more non-transitory computer-readable storage media of claim 18, wherein the one or more convolution kernels comprises respective one or more kernel functions.

20. The one or more non-transitory computer-readable storage media of claim 19, wherein the one or more kernel functions are associated with respective one or more time-varying thresholds.
